(19) United States
(12) Patent Application Publication
(10) Pub. No.: US 2012/0112545 A1
(43) Pub. Date: May 10, 2012

(54) M2LC System Coupled to a Rectifier System

(75) Inventors: Marc Francis AIELLO, Oakmont, PA (US); Dustin Matthew KRAMER, Fort Collins, CO (US); Kenneth Stephen BERTON, Greensburg, PA (US)

(73) Assignee: Curtiss-Wright Electro-Mechanical Corporation, Cheswick, PA (US)

(21) Appl. No.: 13/289,005

(22) Filed: Nov. 4, 2011

Related U.S. Application Data
(60) Provisional application No. 61/410,118, filed on Nov. 4, 2010.

(51) Int. Cl. H02J 9/00; H02M 3/335

(52) U.S. Cl. 307/65; 307/64; 307/66; 363/17

(57) ABSTRACT

A system. The system is a modular multilevel converter system and includes a plurality of series connected modular multilevel converter cells. At least one of the modular multilevel converter cells is a three-level modular multilevel converter cell. The plurality of series connected modular multilevel converter cells are coupled to a rectifier system via a DC bus.

### CROSS-REFERENCE TO RELATED APPLICATION

This application claims the benefit under 35 U.S.C. §119(e) of the earlier filing date of U.S. Provisional Patent Application No. 61/410,118 filed on Nov. 4, 2010.

### BACKGROUND

This application discloses an invention which is related, generally and in various embodiments, to a modular multilevel converter (M2LC) system coupled to a rectifier system. The rectifier system is external to the M2LC cells of the M2LC system, and supplies the DC link voltage for the M2LC system.

Traditional multi-phase (e.g., 3-phase) topologies have been utilized with various configurations of two-terminal cells placed in series to effectively increase the voltage rating of each phase. The two-terminal cells are also referred to as subsystems or as sub-modules. For example, two-terminal cells have been utilized with bridge topologies with current source inverters and voltage source inverter configurations. FIG. 1 illustrates a traditional two-terminal cell which has been utilized in current source inverters, and FIG. 2 illustrates another traditional two-terminal cell which has been utilized in series insulated gate bipolar transistor (IGBT) voltage source inverters.

As shown in FIG. 1, the two-terminal cell utilized in current source inverters includes a thyristor, and the voltage presented across the two terminals can be controlled by controlling the voltage applied to the gate of the thyristor. As shown in FIG. 2, the two-terminal cell utilized in series IGBT voltage source bridge inverters includes a field-effect transistor and a diode, and the voltage presented across the two terminals can be controlled by controlling the voltage applied to the gate of the field-effect transistor.

These bridge topologies have also been utilized with diode-based rectifiers and IGBT-based rectifiers to supply their DC bus voltage (or current). Like the individual two-terminal inverter cell described above, these systems of rectifiers have been placed in series to increase the voltage rating of the inverters they supply. The rectifiers operate to convert AC source energy (e.g., AC source energy usually from a multiphase power transformer) to DC power.

Diode-based rectifiers and/or IGBT-based rectifiers have also been utilized with Cascaded H-Bridge (CCH) medium voltage drive topologies. The diode-based rectifiers allow for two-quadrant power flow (AC source to AC load) through a system, and the IGBT-based rectifiers allow for four-quadrant power flow (both AC source to AC load and AC load to AC source) through a system. FIG. 3 illustrates a diode-based rectifier and FIG. 4 illustrates an IGBT-based rectifier which has been utilized with both the traditional bridge and CCH topologies. In the case of the bridge topology, rectifiers have been placed in series to develop the required DC link voltage. In the case of CCH, these rectifier modules are placed in the individual power cells so that they can provide DC power local to each two-terminal cell.

Many papers have been published regarding a topology similar to the simplicity of the bridge topology but also possessing the features of the CCH topology, namely the Modular Multilevel Converter (M2LC) topology. The M2LC topology possesses the advantages of the CCH topology in that it is modular and capable of high operational availability due to redundancy. Like the series thyristor or IGBT bridge topology described above, the M2LC topology is configured using a series connection of two-terminal cells (subsystems or sub-modules) to increase voltage rating or availability. However, unlike a standard bridge configuration of simple series switches, these sub-modules can be controlled independently to produce at least two or more distinct voltage levels like the CCH topology. Additionally, the M2LC topology can be applied in common bus configurations with and without the use of a multi-winding transformer. In contrast to M2LC, CCH requires the utilization of a multi-winding transformer which contains individual secondary windings which supply input energy to the cells.

However, unlike CCH, the M2LC cells are not independently supplied from isolated voltage sources or secondary windings. For a given M2LC cell, the amount of energy output at one of the two terminals depends on the amount of energy input at the other one of the two terminals.

Multiple M2LC cells have previously been arranged in a traditional bridge configuration. For example, FIG. 5 illustrates an M2LC system having a plurality of M2LC cells arranged in a bridge configuration. As shown in FIG. 5, the M2LC cells are arranged into two or more output phase modules, each output phase module includes a plurality of series-connected M2LC cells, and each output phase module is further arranged into a positive arm (or valve) and a negative arm (or valve), where each arm (or valve) is separated by an inductive filter. For purposes of simplicity, the inductive filters are not shown in FIG. 5. Each positive and negative output phase module may be considered to be a pole. The outputs of these respective poles may be utilized to power an alternating current load such as, for example, a motor.

Although diode-based rectifiers and IGBT-based rectifiers have been utilized with various bridge and CCH topologies, such rectifiers have not been utilized with M2LC systems. Thus, it logically follows that such rectifiers have also not been utilized to supply the DC bus of an M2LC system, to allow two-quadrant power flow (diode) through an M2LC system, or to allow four-quadrant power flow (diode or IGBT) through an M2LC system by simply exchanging the type of rectifier (diode or IGBT) in the M2LC system. Furthermore, means of electrical energy storage within each two-terminal cell has not been utilized in M2LC based systems to take advantage of the redundancy features of this topology.

### BRIEF DESCRIPTION OF THE DRAWINGS

Various embodiments of the invention are described herein in by way of example in conjunction with the following figures, wherein like reference characters designate the same or similar elements.

FIG. 1 illustrates a two terminal cell;

FIG. 2 illustrates another two terminal cell;

FIG. 3 illustrates a diode-based rectifier;

FIG. 4 illustrates an IGBT-based rectifier;

FIG. 5 illustrates an M2LC system;

FIG. 6 illustrates a simplified representation of an M2LC system coupled to a rectifier system according to various embodiments;

FIG. 7 illustrates a more detailed representation of the M2LC system and rectifier system of FIG. 6;

FIG. 8 illustrates various embodiments of a two-level M2LC cell of the M2LC system of FIG. 6;

FIG. 9 illustrates other embodiments of a two-level M2LC cell of the M2LC system of FIG. 6;

FIG. 10 illustrates various embodiments of a three-level M2LC cell of the M2LC system of FIG. 6;

FIG. 11 illustrates other embodiments of a three-level M2LC cell of the M2LC system of FIG. 6;

FIG. 12 illustrates various embodiments of a DC link system connecting M2LC systems to themselves or other rectifier systems; and

FIG. 13 illustrates various embodiments of an M2LC system having an energy storage system incorporated into the M2LC cells.

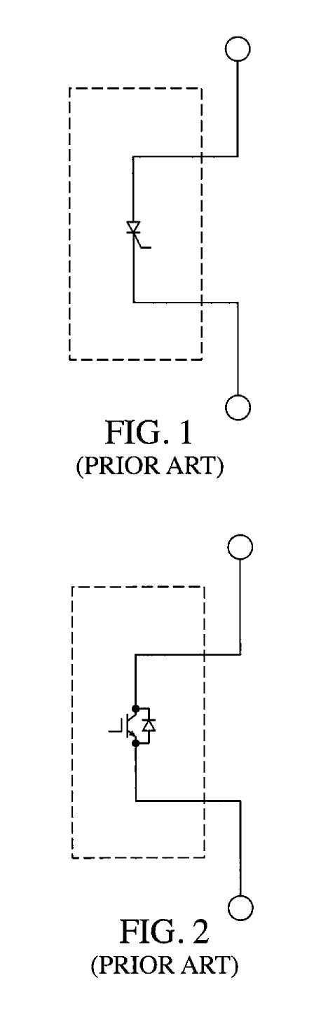

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

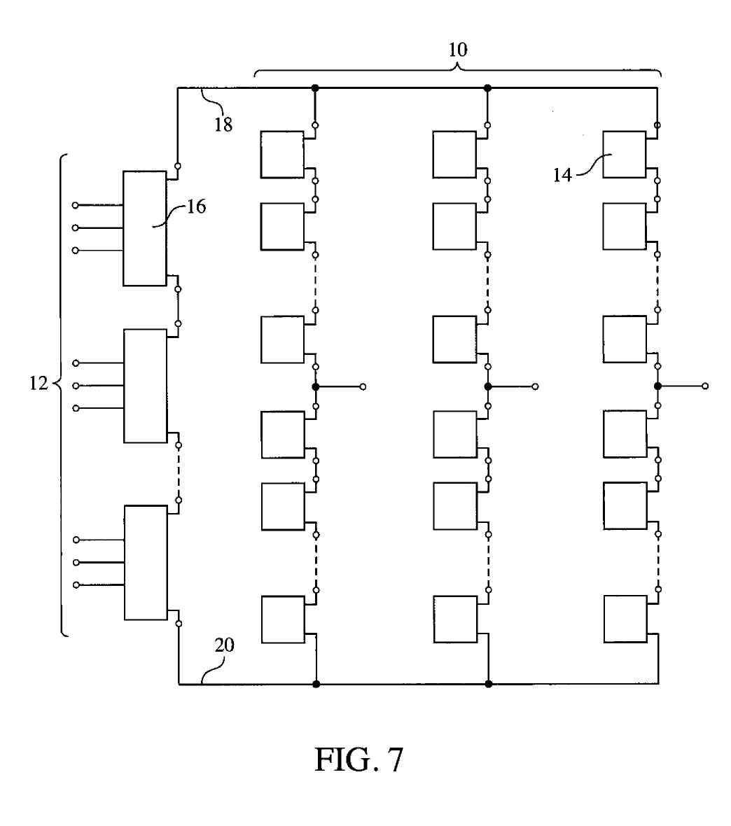

FIG. 6 illustrates a simplified representation of an M2LC system 10 coupled to a rectifier system 12 according to various embodiments. A more detailed representation of the M2LC system 10 and the rectifier system 12 is shown in FIG. 7. The M2LC system 10 is configured as a three-phase bridge and includes a plurality of M2LC cells 14, where the M2LC cells 14 are arranged as three output phase modules. Although eighteen M2LC cells 14 are shown in FIG. 7, it will be appreciated that the M2LC system 10 may include any number of M2LC cells 14. Of course, according to other embodiments, the M2LC system 10 may be configured differently than shown in FIG. 7. For example, the M2LC system may be configured as consisting of only two output poles or four or more output poles depending on the number of load phases required for a given application.

For the M2LC system 10 shown in FIG. 7, the plurality of M2LC cells 14 are arranged as output phase modules or arms. Each output phase module is further arranged into a positive arm (or valve) and a negative arm (or valve), where each arm (or valve) is separated by an inductive filter (not shown in FIG. 7 for purposes of clarity). Each output phase module may be considered to be an arm of a pole. Additionally, although not shown in FIG. 7 for purposes of clarity, it will be appreciated that each M2LC cell 14 also includes a local controller, and each local controller may be communicably connected to a higher level controller (e.g., a hub controller) of the M2LC system 10.

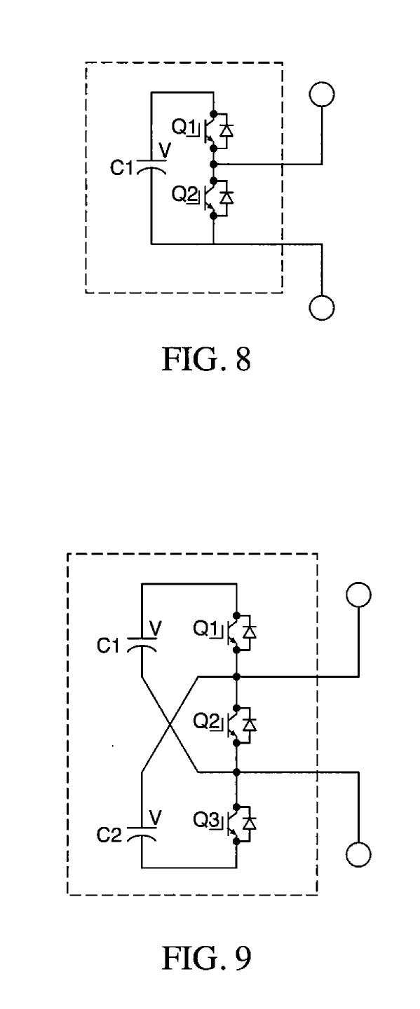

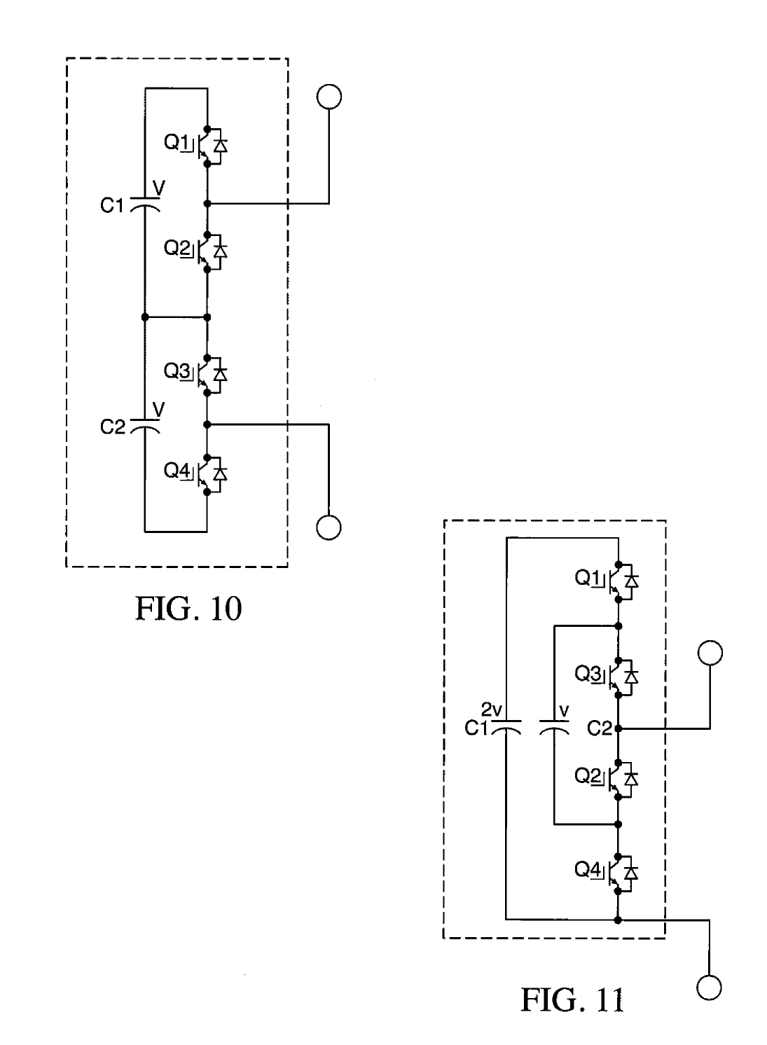

The M2LC cells 14 utilized in the M2LC system 10 may be any suitable type of two-terminal M2LC cells. For example, FIG. 8 illustrates a two-level configuration of an M2LC cell having two terminals, FIG. 9 illustrates another two-level configuration of an M2LC cell having two terminals, FIG. 10 illustrates a three-level configuration of an M2LC cell having two terminals, and FIG. 11 illustrates another three-level configuration of an M2LC cell having two terminals.

The M2LC cell shown in FIG. 8 includes two switching devices (Q1 and Q2), two diodes, a capacitor (C1) and two terminals. With the configuration shown in FIG. 8, the two switching devices can be controlled such that one of two different potentials (e.g., zero volts or V) may be present across the two terminals. For example, when switching device Q2 is turned on, zero volts are present between the two terminals of the M2LC cell. When switching device Q1 is turned on, the voltage V (the voltage present on storage capacitor C1) is present between the two terminals of the M2LC cell. It will be appreciated that in order to avoid short circuiting of the storage capacitor C1 and the significant damage likely to result therefrom, switching device Q1 should be off when switching device Q2 is on, and switching device Q2 should be off when switching device Q1 is on.

The M2LC cell shown in FIG. 9 includes three switching devices (Q1, Q2 and Q3), three diodes, two capacitors (C1 and C2) and two terminals. With the configuration shown in FIG. 9, the three switching devices Q1-Q3 can be selectively controlled such that one of two different potentials (e.g., zero volts or V) may be present across the two terminals of the M2LC cell. For example, when switching device Q2 is turned on (and switching devices Q1 and Q3 are off), zero volts are present between the two terminals of the M2LC cell. Also, when switching device Q2 is turned on, the capacitors C1 and C2 are physically connected in series (but not with respect to the two output terminals). When switching devices Q1 and Q3 are both turned on (and switching device Q2 is off), the voltage V (the voltage present on storage capacitors C1 and C2) is present between the two terminals of the M2LC cell. Also, when switching devices Q1 and Q3 are both turned on (and switching device Q2 is turned off), the capacitors C1 and C2 are connected in parallel with respect to the two output terminals. It will be appreciated that the load current is equally shared by the capacitors C1 and C2 of M2LC cell of FIG. 9.

The three-level M2LC cell shown in FIG. 10 includes four switching devices (Q1, Q2, Q3 and Q4), four diodes, two capacitors (C1 and C2) and two terminals. It will be appreciated that capacitors C1 and C2 are typically identical for this arrangement. With the configuration shown in FIG. 10, the four switching devices can be controlled such that one of three different potentials (e.g., zero volts, V_{C1}, V_{C2}, or V_{C1}+V_{C2}) may be present across the two terminals of the M2LC cell. Because the two capacitors C1 and C2 are typically identical, it will be appreciated that the voltages V_{C1} and V_{C2} are substantially identical, and the voltage V_{C1}+V_{C2} is substantially identical to either 2V_{C1} or 2V_{C2}.

For the M2LC cell of FIG. 10, when switching devices Q2 and Q3 are both turned on, zero volts are present between the two terminals of the M2LC cell. When switching devices Q1 and Q3 are both turned on, the voltage V_{C1} (the voltage present on storage capacitor C1) is present between the two terminals of the M2LC cell. When switching devices Q2 and Q4 are both turned on, the voltage V_{C2} (the voltage present on storage capacitor C2) is present between the two terminals of the M2LC cell. When switching devices Q1 and Q4 are both turned on, the voltage V_{C1}+V_{C2} is present between the two terminals of the M2LC cell. It will be appreciated that the independent control of the two voltage states V_{C1} and V_{C2} allow for the balancing of the charges on capacitors C1 and C2.

The M2LC cell shown in FIG. 11 includes four switching devices (Q1, Q2, Q3 and Q4), four diodes, two capacitors (C1 and C2) and two terminals. With the configuration shown in FIG. 11, the four switching devices can be controlled in the M2LC cell such that one of three different potentials (zero volts, V and 2V) can be present across the two terminals. In contrast to the two equal size storage capacitors of the M2LC cell shown in FIG. 10, the respective sizes of the two capacitors of M2LC cell are not identical to one another. Capacitor C1 is a storage capacitor and capacitor C2 is a so-called “flying” capacitor (capacitor C2 does not conduct the fundamental output current).

The switching devices Q1-Q4 of the M2LC cell of FIG. 11 can be controlled so that the voltage present on capacitor C1 is 2V, which is double the voltage V which can be present on capacitor C2. The voltage on capacitor C2 is controlled so that each switching device sees no more than V. Stated differently, the voltage on capacitor C2 is controlled so that each switching device sees no more than one-half of the voltage which can be present on capacitor C1. To accomplish this, C2 is controlled to voltage value 2V. The M2LC cell is arranged such that switching device Q1 is a complement of switching device Q2, and switching device Q3 is a complement of switching device Q4.

When switching devices Q2 and Q4 are both turned on, zero volts are present between the two terminals of the M2LC cell. When switching devices Q3 and Q4 are both turned on, the voltage V_{C2} (the voltage “v” present on flying capacitor C2) is present between the two terminals of the M2LC cell. When switching devices Q1 and Q2 are both turned on, the voltage V_{C1-C2}, which is equal to the voltage V_{C1}-V_{C2} (which is also “v” if “2 v” is the voltage on C1 and “v” is the voltage on C2), is present between the two terminals of the M2LC cell. When switching devices Q1 and Q3 are both turned on, the voltage V_{C1} (which is “2 v” if this is the voltage on C2) is present between the two terminals of the M2LC cell. In this way, the output voltage characteristic of the M2LC cell of FIG. 11 is essentially identical to the output voltage characteristic of the M2LC cell of FIG. 10 in that it produces three voltage levels (e.g., zero volts, “v” volts and “2 v” volts) with two independent switching modes to produce “v” but it does so using a single storage capacitor C1 which conducts the fundamental output current produced at the output terminals of the M2LC cell. Capacitor C2 is a charge/pump capacitor or so called flying capacitor which operates at the switching frequency of the switching devices Q1-Q4 and hence sees only harmonic currents associated with the switching frequency.

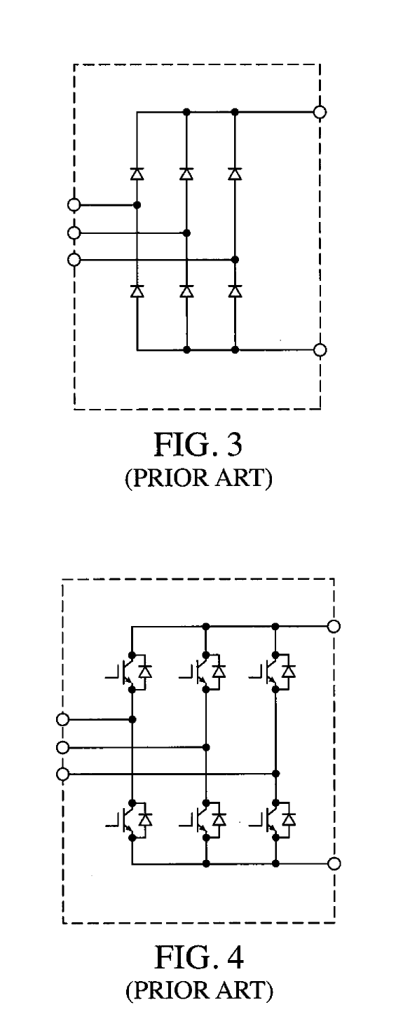

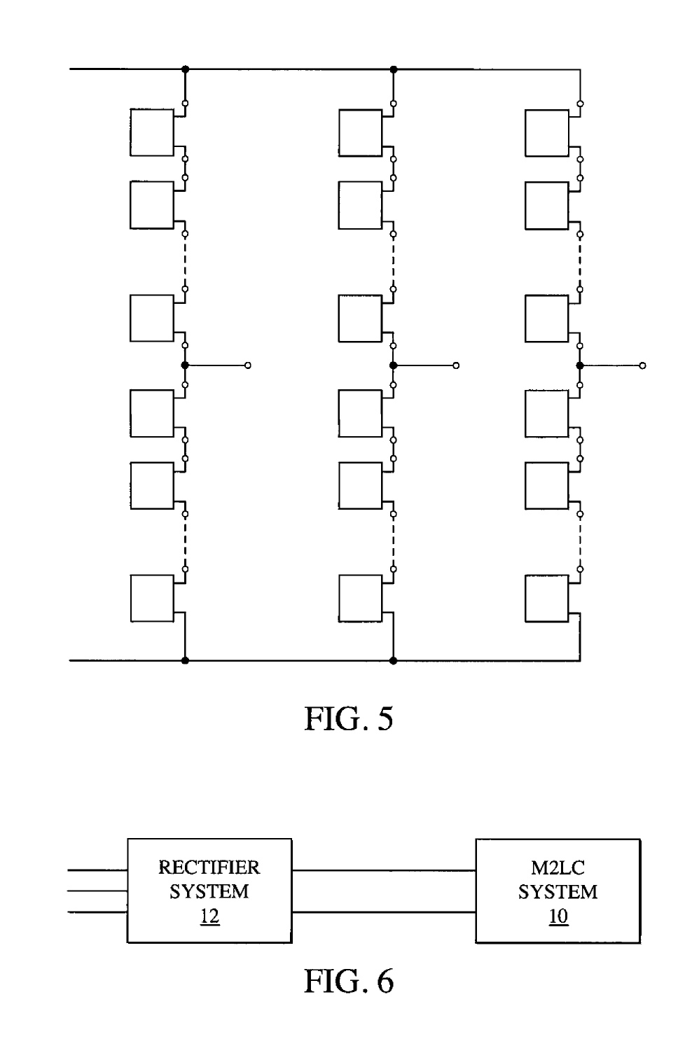

Returning to FIG. 7, the rectifier system 12 includes a plurality of series-connected rectifiers 16. Although three rectifiers 16 are shown in FIG. 7, it will be appreciated that the rectifier system 12 may include any number of series-connected rectifiers 16. The rectifiers 16 may be any suitable type of rectifiers (e.g., 2-quadrant, 4-quadrant, diode-based, IGBT-based, and combinations thereof). For example, the rectifiers 16 may be embodied as any of the rectifiers shown in FIGS. 3 and 4. According to various embodiments, the 3 phase AC supply to these rectifiers 16 can be supplied from a multi-secondary winding phase shifted isolation transformer (not shown in FIG. 7 for purposes of clarity). According to various embodiments, the rectifier system is an interchangeable rectifier system 12 in that any of the rectifiers 16 may be changed-out with a different type of rectifier (e.g., changing out a 2-quadrant rectifier with a 4-quadrant rectifier) to meet the requirements of a given application.

As shown in FIG. 7, one terminal of the rectifier system 12 (e.g., one terminal of one of the series-connected rectifiers 16) is connected to the positive DC bus 18 of the M2LC system 10 and another terminal of the rectifier system 12 (e.g., one terminal of another one of the series-connected rectifiers 16) is connected to the negative bus 20 of the M2LC system 10. The rectifier system 12 supplies the applicable DC voltage to the respective positive and negative DC buses 18, 20 of the M2LC system 10. Depending on the type of rectifiers 16 utilized, either two-quadrant (diode) or four-quadrant (IBBT) power may flow through the M2LC system 10 in both two-quadrant or four-quadrant mode. It will be appreciated that according to various embodiments, the rectifier system 12 may be configured such that diode-based rectifiers can be easily replaced with IGBT-based rectifiers, and IGBT-based rectifiers can easily be replaced, at any point during manufacturing or after the rectifier system 12 is placed into operation with the M2LC system 10 in the field.

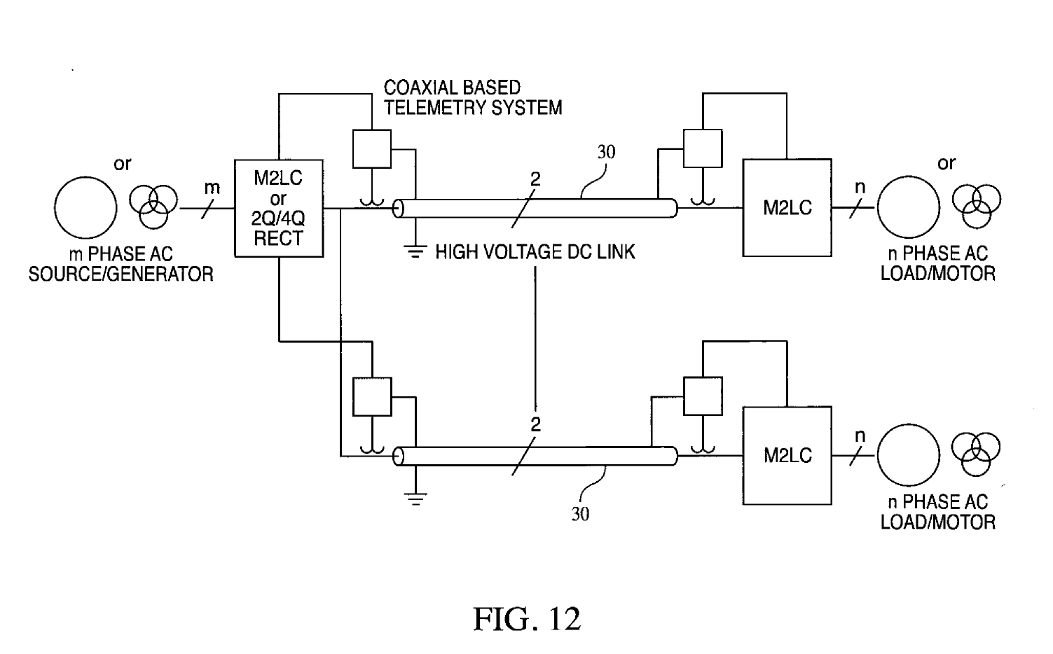

FIG. 12 illustrates various embodiments of a DC link system 30. The DC link system 30 includes a source converter, a high voltage DC link, and a load converter. The DC link system 30 may be utilized to transfer power over large distances via high DC voltage links. As shown in FIG. 12, the DC link system 30 may utilize a telemetry system with the high voltage DC link to realize communications between source and load converters without having to use a separate information link. According to various embodiments, the source converter may be embodied as an M2LC bridge, as a series connection of diode-based rectifiers, or as a series connection of IGBT-based rectifiers. According to various embodiments, the load converter may include a two-level M2LC cell, a three-level M2LC cell and/or combinations thereof. For example, the load converter may include any of the M2LC cells shown in FIGS. 8-11.

In operation, the high voltage DC link of the DC link system 30 acts like a current source, and a fault on the high voltage DC link causes energy supplied by either the source or load (or both) to flow, but does not cause energy supplied by the distributed energy storage in each two-terminal M2LC cell to flow. Thus, it will be appreciated that standard AC protection breakers can be used to remove energy from the fault on the AC side and no high current fault current flows from the storage capacitors of the M2LC cells into the fault. Also, since each M2LC cell is an individual voltage source, high values of DC link inductance will not result in resonance between this inductance and the cell capacitance of the M2LC cell. Therefore, very long distances of high voltage cable can be used with no particular limitation on controlling the resulting inductance due to spacing considerations.

It will be appreciated that there are many applications which could utilize the DC link system 30 of FIG. 12 to control and transmit power between AC source and load. The loads may be mechanical prime movers such as motors or generators or can be existing multiphase AC power systems. The DC link system 30 is particularly well-suited for such applications where the distances between the source and the load are large (requiring high voltage DC to reduce transmission cost) and the applications require high availability (ability to add redundant two-terminal M2LC cells to increase availability).

For example, the DC link system 30 is particularly well-suited for the following applications:
Wind power applications where the pod of each turbine may include an M2LC inverter and all pods in a farm can be connected via single high voltage DC link. These systems would generally use M2LC inverters on both the Source and Load sides.
Tidal power applications where a multitude of generators are submerged in either fixed locations or movable locations beneath the sea surface in order to extract tidal energy directly from water flow or tidal head changes which drive a pump/generator. Like the wind power applications, these generators can be linked by a single DC link to the main M2LC inverter. These applications would generally use the M2LC inverters on both the Source and Load sides
Sub sea pumping applications where the M2LC inverter along with the pump motor resides at long distances from a central platform which supplies power. In these applications, the source may include a two-quadrant rectifier, fed by a multi-winding phase shifted transformer, rather than an M2LC cell system.
ID and FD Coal Power Utility or Nuclear Power recalculating pump applications which may use multiple motor/fans or motor/pumps fed from a single DC link which could be supplied by (1) a two-quadrant rectifier or a four-quadrant rectifier fed by a multi-winding phase shifted transformer, or (2) an M2LC inverter fed by a single (typically) three-phase source.
Marine Propulsion system applications which may include a single high frequency AC generator supplying an M2LC inverter which supplies a high voltage/high power DC link which can be used for various main drive or thruster applications where each drive or thruster may also be an AC or high frequency AC machine.

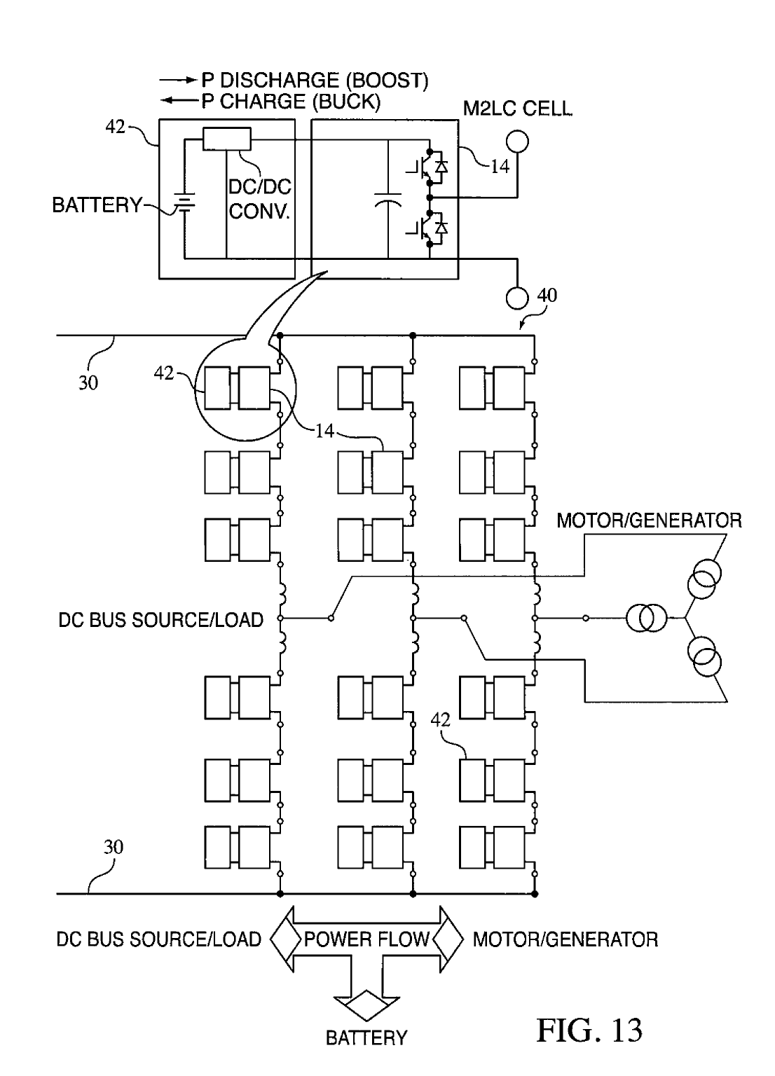

FIG. 13 illustrates various embodiments of an M2LC system 40. The M2LC system 40 may be similar to the M2LC system 10 described hereinabove, and/or similar to the source side converter and/or the load side converter of the DC link system 30, but is different in that one or more of the M2LC cells 14 of the M2LC system 40 is coupled to an electrical energy storage system. The energy storage system is supplemental to any electrical energy storage devices (e.g., capacitors) typically present in a “traditional” M2LC cell, and may be controlled so as to absorb energy from and/or supply energy to the DC and/or AC connections of the M2LC cells. According to various embodiments, the energy storage system includes a plurality of energy storage subsystems 42, and any or all of the M2LC cells 14 included in the M2LC system 40 may be coupled to and/or integral with corresponding energy storage subsystems 42. Each of the energy storage subsystems 42 may include one or more energy storage devices such as, for example, a battery. As shown in FIG. 13, any or all of the M2LC cells 14 can be configured with battery storage and DC to DC converters local to each M2LC cell 14. Although the M2LC cell 14 shown in the exploded view in FIG. 13 is a two-level M2LC cell, it will be appreciated that the M2LC system 40 of FIG. 13 may include a two-level M2LC cell, a three-level M2LC cell and/or combinations thereof. For example, the M2LC system 40 may include any of the M2LC cells shown in FIGS. 8-11. Although the energy storage system is shown in FIG. 13 as being coupled to the “load side” modular multilevel converter system, it will be appreciated that according to other embodiments, the energy storage system is coupled to the “source” side modular multilevel converter system.

Many electro-mechanical energy systems (e.g., motor or generator applications) require or could take advantage of the energy storage system. In the case of motor applications, the energy storage system may be utilized to provide significant ride thru during loss of source power. In the case of generator applications, the energy storage system may be utilized to provide continued electrical energy during a loss of mechanical energy (for instance loss of wind in a wind farm application).

According to various embodiments, by configuring the M2LC cells with battery storage, the single point of failure associated with a single battery storage system could be eliminated by distributing the battery storage and associated power processing inside or adjacent to the M2LC cell itself. This could be accomplished by applying bypass and redundancy features for the M2LC cells and the M2LC system 40.

For the M2LC cell 14 shown in an exploded view in FIG. 13, the DC to DC converter is a bilateral power converting device capable of transferring charging current from the M2LC capacitor (typically higher voltage) to a suitable battery (typically lower voltage) when excess electrical or mechanical energy from the DC Source/Load or AC Motor/Generator is available. Conversely this same DC to DC converter would delivery energy (discharge current from the battery) when electrical or mechanical energy from the DC Source/Load or AC Motor/Generator is needed. Although not shown for purposes of simplicity, it will be appreciated that this DC to DC converter may have an associated control which would act locally or from a central hub control to allow for at least the following three operating modes:

Voltage regulation of the individual M2LC capacitors with current limit control for charge or discharge currents;

Current regulation of the charge or discharge currents with voltage limit control of the M2LC capacitor; and

Power regulation of the charge or discharge energy with the above-described current and voltage limits.

The battery associated with each M2LC cell may be based on any suitable technology. For example, according to various embodiments, the battery may be based on the Vanadium Redox Flow technology where each M2LC cell would contain the electrodes and membrane stack where the actual bulk electrical storage energy in via a set of large central electrolyte tanks which supply + and − Vanadium ions via pipes to the M2LC cell/battery membrane.

Similarly, according to various embodiments, any or all of the M2LC cells 14 included in the M2LC system 10 of FIG. 7, the source or load M2LC converters shown in FIG. 12 or the DC link system 30 of FIG. 12 may be coupled to and/or integral with the above-described energy storage system.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A modular multilevel converter system, comprising:
a plurality of series connected modular multilevel converter cells, wherein at least one of the modular multilevel converter cells is a three-level modular multilevel converter cell, and wherein the plurality of series connected modular multilevel converter cells are coupled to a rectifier system via a DC bus.

2. The system of claim 1, wherein at least one other modular multilevel converter system is coupled to the rectifier system.

3. The system of claim 1, wherein the rectifier system comprises a plurality of series connected rectifiers.

4. The system of claim 1, wherein the rectifier system is an interchangeable rectifier system.

5. The system of claim 1, wherein the rectifier system comprises at least one diode-based rectifier.

6. The system of claim 1, wherein the rectifier system comprises at least one insulated gate bipolar transistor-based rectifier.

7. The system of claim 1, further comprising a supplemental and controllable electrical energy storage system coupled to one or more of the modular multilevel converter systems.

8. The system of claim 7, wherein at least one of the modular multilevel converter cells of the one or more modular multilevel converter systems comprises:
a battery storage device; and
a DC-to-DC converter coupled to the battery storage device.

9. The system of claim 7, wherein the energy storage system comprises a plurality of energy storage subsystems, wherein:
a first one of the plurality of energy storage subsystems is coupled to a first series connected modular multilevel converter cell; and
a second one of the plurality of energy storage subsystems is coupled to a second series connected modular multilevel converter cell.

10. The system of claim 9, wherein the first one of the plurality of energy storage subsystems comprises:
a battery storage device; and
a DC-to-DC converter coupled to the battery storage device.

11. The system of claim 1, further comprising a telemetry system coupled to the plurality of series connected modular multilevel converter cells.

12. A modular multilevel converter system, comprising:
a plurality of series connected modular multilevel converter cells; and
a supplemental and controllable electrical energy storage system coupled to one or more of the modular multilevel converter cells, wherein the electrical energy storage system is configured to:
receive energy from at least one of the following:
an AC terminal of the modular multilevel converter system; and
a DC bus of the modular multilevel converter system; and
supply energy to at least one of the following:
an AC terminal of the modular multilevel converter system; and
a DC bus of the modular multilevel converter system.

13. The system of claim 12, wherein at least one of the modular multilevel converter cells is a two-level modular multilevel converter cell.

14. The system of claim 12, wherein at least one of the modular multilevel converter cells is a three-level modular multilevel converter cell.

15. The system of claim 12, wherein at least one of the modular multilevel converter cells comprises:
a battery storage device; and
a DC-to-DC converter coupled to the battery storage device.

16. The system of claim 12, wherein the energy storage system comprises a plurality of energy storage subsystems, wherein:
a first one of the plurality of energy storage subsystems is coupled to a first one of the plurality of series connected modular multilevel converter cells; and
a second one of the plurality of energy storage subsystems is coupled to a second one of the plurality of series connected modular multilevel converter cells.

17. The system of claim 16, wherein the first one of the plurality of energy storage subsystems comprises:
a battery storage device; and
a DC-to-DC converter coupled to the battery storage device.

18. The system of claim 12, wherein the modular multilevel converter system is coupled to one or more other modular multilevel converter systems.

19. The system of claim 18, wherein the electrical energy storage system is further configured to:
receive energy from the one or more other modular multilevel converter systems; and
supply energy to the one or more other modular multilevel converter systems.

20. The system of claim 18, further comprising a telemetry system coupled to at least two of the modular multilevel converter systems.
